(19) United States
(12) Patent Application Publication
(10) Pub. No.: US 2016/0029668 A1
(43) Pub. Date: Feb. 4, 2016

(54) PALATANT COMPOSITIONS FROM FATS, OILS OR FATTY ACIDS

(71) Applicant: NESTEC SA, Vevey (CH)

(72) Inventors: Haiqing Nancy Yu, St. Louis, MO (US); Delphine Tissot-Favre, Gollion (CH); Kornel Nagy, Lausanne (CH)

(21) Appl. No.: 14/812,544

(22) Filed: Jul. 29, 2015

Related U.S. Application Data
(60) Provisional application No. 62/030,656, filed on Jul. 30, 2014.

(51) Int. Cl. A23K 1/16; A23K 1/00

(52) U.S. Cl. CPC A23K 1/1609; A23K 1/164; A23K 1/004; A23K 1/003

(57) ABSTRACT

A palatant composition can be derived from cocoa butter or a fat blend with a similar compositional profile and can be combined with a food composition to enhance the palatability of the food composition. Alternatively or additionally, a mixture of different fatty acids can be used. Mono-ethanolamine can be subjected to a heat treatment and an amidation reaction with the fat blend to make the palatant composition. The resultant palatant composition can be used with the food composition at a ppm level, for example 10-1000 ppm relative to the food composition. The palatant composition can also be delivered in a free-flowing, encapsulated form and packed in a sachet to use as supplement to main meals.

### CROSS REFERENCE TO RELATED APPLICATIONS

This application claims priority to U.S. Provisional Application No. 62/030,656 filed Jul. 30, 2014, the disclosure of which is incorporated herein by this reference.

### BACKGROUND

The present disclosure relates generally to palatant compositions derived from fats, oils or fatty acids; food products containing such compositions; and methods for making such palatant compositions. More specifically, the present disclosure is directed to a palatant composition that can be used as a coating on dry pet food and/or incorporated into a dry pet food ingredient blend before extrusion-cooking thereof.

Pet food is not necessarily organoleptically pleasing to the animal consuming it, particularly for dry pet food. Palatants are compounds added to enhance the flavor of pet food. Palatability enhancement is an important factor in the competition between pet food manufacturers in the market place. Most palatability enhancers for pet food are liquid animal digests produced by chemical and/or enzymatic hydrolysis of clean and undecomposed animal tissue. These liquid animal digests are frequently applied to animal foods as a coating that provides natural flavoring. However, liquid animal digests must be used in significant amounts to impart their palatability effect, typically at least 1.0 wt % or more relative to the pet food.

N-oleoyl-ethanolamide (OEA) has been suggested as an alternative palatability enhancer. However, raw material having a high oleic acid content is a challenge and is costly, and some of these materials have components that do not provide palatability enhancement.

### SUMMARY

The present disclosure relates generally to palatant compositions derived from fats, oils or fatty acids; food products containing such compositions; and methods for making such palatant compositions. More specifically, the present disclosure is directed to using cocoa butter, or a fat or oil having a similar compositional profile, in an amidation process. Alternatively or additionally, a fatty acid can be used. The resultant palatant composition can be used at a ppm level, for example 10-1000 ppm. The resultant palatant composition can be a coating on dry pet food kibbles and/or can be incorporated into the kibble matrix blend before extrusion-cooking thereof.

Accordingly, in a general embodiment, the present disclosure provides a method of enhancing the palatability of a food composition. The method comprises: subjecting mono-ethanolamine (MEA) to a heat treatment and an amidation reaction with a mixture of different fatty acids to form a palatability composition comprising a mixture of different ethanolamides; and mixing the palatability composition with the food composition.

in an embodiment, each of the different fatty acids is individually selected from the group consisting of oleic acid, palmitic acid, linoleic acid, and linolenic acid.

In an embodiment, the heat treatment is performed at a temperature of 115° C.-120° C.

In an embodiment, the amidation reaction comprises contacting the heated MEA with the mixture of different fatty acids for a predetermined time period.

In an embodiment, the mixing of the palatability composition with the food composition comprises coating the food composition with at least a portion of the palatability composition. The food composition can be a pet food kibble that is coated with at least a portion of the palatability composition.

In an embodiment, the mixing of the palatability composition with the food composition comprises mixing at least a portion of the palatability composition in an ingredient blend that is used to make the food composition. The food composition can be a pet food kibble, and the ingredient blend comprising at least a portion of the palatability composition can be extruded to form the pet food kibble.

In another embodiment, the present disclosure provides a method of enhancing the palatability of a food composition. The method comprises: subjecting mono-ethanolamine (MEA) and oil to a heat treatment and an amidation reaction with an amidation catalyst to form a palatability composition comprising a mixture of different ethanolamides; and mixing the palatability composition with the food composition.

In an embodiment, the oil is selected from the group consisting of beef tallow, cocoa butter, palm oil, palm stearin, palm fractions, olive oil, hydrogenated oils, lard, high oleic safflower oil, and combinations thereof.

In an embodiment, the heat treatment is performed at a temperature of 90° C.-95° C.

In an embodiment, the amidation reaction comprises contacting the heated MEA with the oil and the amidation catalyst for a predetermined time period.

In an embodiment, the mixing of the palatability composition with the food composition comprises coating the food composition with at least a portion of the palatability composition. The food composition can be a pet food kibble that is coated with at least a portion of the palatability composition.

In an embodiment, the mixing of the palatability composition with the food composition comprises mixing at least a portion of the palatability composition in an ingredient blend that is used to make the food composition. The food composition can be a pet food kibble, and the ingredient blend comprising at least a portion of the palatability composition can be extruded to form the pet food kibble.

In another embodiment, the present disclosure provides a food product comprising: a pet food composition; and a palatability composition made by a process comprising (i) subjecting mono-ethanolamine (MEA) to a heat treatment and an amidation reaction with a mixture of different fatty acids or (ii) subjecting MEA and an oil to a heat treatment and an amidation reaction with an amidation catalyst. The pet food composition can be a kibble, and the palatability composition can be in a position selected from the group consisting of (i) a coating on the kibble, (ii) incorporated into a matrix of the kibble, and (iii) a combination thereof.

In another embodiment, the present disclosure provides palatability composition made by a process comprising (i) subjecting mono-ethanolamine (MEA) to a heat treatment and an amidation reaction with a mixture of different fatty acids or (ii) subjecting MEA and an oil to a heat treatment and an amidation reaction with an amidation catalyst.

An advantage of the present disclosure is to provide a palatant that increases the palatability of a food composition to which the palatant is applied and/or included, relative to the palatability of the food composition in the absence of the palatant.

Another advantage of the present disclosure is to improve palatability without using costly materials, such as raw materials high in free oleic acid content.

A further advantage of the present disclosure is to provide a palatant that can be applied directly to a food composition. with minimal further processing or no further processing.

Still another advantage of the present disclosure is to improve palatability of a food composition without relying on a liquid digest, preferably without using a liquid digest.

Yet another advantage of the present disclosure is to improve palatability of a food composition using starting materials that are easy to obtain.

Another advantage of the present disclosure is to improve palatability of a food composition at low costs due to the ability to use ppm amounts of the palatant.

A further advantage of the present disclosure is to improve palatability of a food composition with a compound that does not require pre-isolation.

Additional features and advantages are described herein and will be apparent from the following Figures and Detailed Description.

### BRIEF DESCRIPTION OF THE DRAWINGS

FIG. 1 shows an embodiment of a method of producing a mixture of different fatty acid ethanolamides that can be used in a palatant provided by the present disclosure.

FIG. 2 shows another embodiment of a method of producing a mixture of different fatty acid ethanolamides that can be used in a palatant provided by the present disclosure.

FIG. 3 shows a table of the dry ingredient mix used in the Example.

FIG. 4 shows a table of the flavor enhancers used in the Example.

FIG. 5 shows a table of palatability results obtained from XEAs produced from oleic acid (OEA), palmitic acid (PEA), stearic acid (SEA), linoleic acid (LEA), and linolenic acid (LnEA) in the Example, (*) indicates that the result is statistically significant.

FIG. 6 shows a table of palatability results obtained, from XEAs produced from beef tallow (BT), cocoa butter (CB), palm oil (PO), and palm stearin (PS) in the Example. (*) indicates that the result is statistically significant.

### DETAILED DESCRIPTION

As used in this disclosure and the appended claims, the singular forms “a,” “an” and “the” include plural referents unless the context clearly dictates otherwise. The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the compositions and products disclosed herein may lack any element that is not specifically disclosed. Thus, a disclosure of an embodiment using the term “comprising” includes a disclosure of embodiments “consisting essentially of” and “consisting of” the components identified.

The terms “food,” “food product” and “food composition” mean a product or composition that is intended for ingestion by an animal and provides at least one nutrient to the animal. The term “pet” means any animal which could benefit from or enjoy the food compositions and products provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat.

The term “pet food” means any composition formulated to be consumed by a pet. “Dry food” is pet food having a water activity less than 0.65. “Semi-moist food” and “intermediate moisture food” is pet food having a water activity from 0.65 to 0.8. “Wet food” is pet food having a water activity more than 0.8.

“Kibbles” are pieces of dry pet food which can have a pellet shape or any other shape. Non-limiting examples of kibbles include particulates; pellets; pieces of pet food, dehydrated meat, meat analog, vegetables, and combinations thereof; and pet snacks, such as meat or vegetable jerky, rawhide, and biscuits. The present disclosure is not limited to a specific form of the kibbles.

The terms “enhanced palatability” and “enhancing palatability” mean that a palatant prepared according to the present disclosure improves the palatability of a food composition relative to an identically formulated food composition lacking the palatant. “Palatability” refers to a quality of a comestible composition that makes it appealing or pleasing to one or more of an animal's senses, particularly the senses of taste and smell. As used herein, whenever an animal shows a preference, for example, for one of two or more foods, the preferred food is more “palatable” and has greater “palatability.” For companion animals and other non-human animals, the relative palatability of one food compared to one or more other foods can be determined, for example, in side-by-side, free-choice comparisons, e.g., by relative consumption of the foods, or other appropriate measures of preference indicative of palatability.

The term “mono-ethanolamine” means mono-ethanolamine and its analogs, homologs, precursors, or combinations thereof. Similarly, “ethanolamides” means ethanolamides and their analogs, homologs, precursors, or combinations thereof.

Ranges are used herein in shorthand to avoid listing every value within the range. Any appropriate value within the range can be selected as the upper value or lower value of the range. Moreover, the numerical ranges herein include all integers, whole or fractions, within the range.

All percentages expressed herein are by weight of the total weight of the food composition unless expressed otherwise. When reference is made to the pH, values correspond to pH measured at 25° C. with standard equipment. As used herein, “about” or “substantially” in reference to a number is understood to refer to numbers in a range of numerals, for example the range of −10% to +10%, preferably −5% to +5%, more preferably −1% to +1%, and even more preferably −0.1% to +0.1% of the referenced number.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred compositions, methods, articles of manufacture, or other means or materials are described herein.

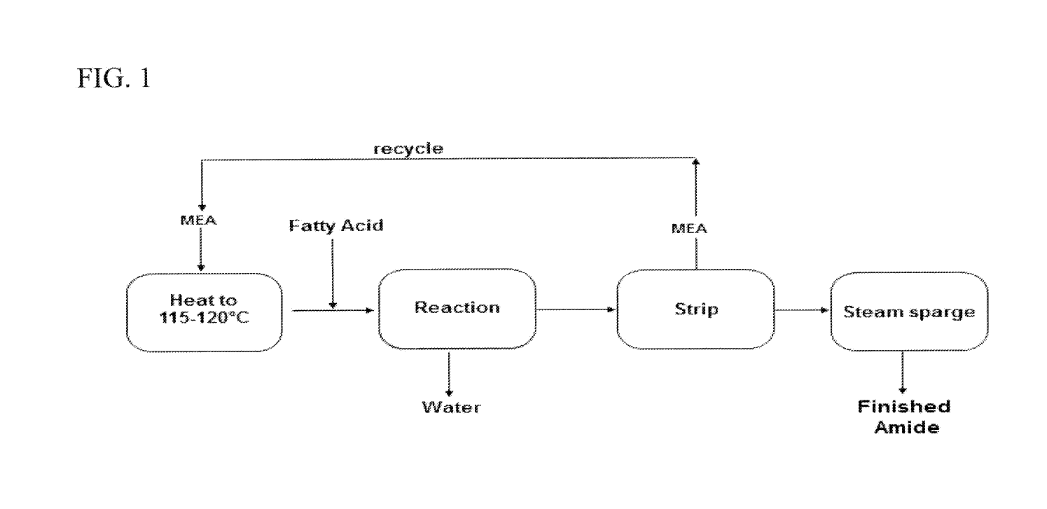

The present disclosure provides a palatant composition that can be made by reacting mono-ethanolamine (MEA) to heat and an amidation process with (i) a mixture of different fatty acids or (ii) cocoa butter and/or another oil blend of a similar compositional profile. In an embodiment shown in FIG. 1, a mixture of different ethanolamides (XEA) can be obtained by reacting MEA with a mixture of different fatty acids, such as oleic acid, palmitic acid, linoleic acid, stearic acid, and/or linolenic acid. The mixture of different fatty acids is identified in FIG. 1 as “Fatty Acid.” The mixture of different fatty acids comprises at least two fatty acids that differ in a characteristic that is one or more of (i) length of the aliphatic tail, (ii) the position of one or more double bonds between carbon atoms, if any such bonds are present in the fatty acid, and (iii) the configuration of the two carbon atoms that are bound next to either side of the double bond.

For example, the MEA can be heated to a predetermined temperature, such as to a temperature of 115° C.-120° C. Then the mixture of different fatty acids can be added for the amidation reaction, for example by contacting the heated MEA with the mixture of different fatty acids for a predetermined time period and/or until the desired quantity of the XEA is formed. Then the unreacted MEA can be stripped off using any process known to one of ordinary skill. The unreacted MEA can be recycled and used in subsequent amidation reactions. The amidation product can then be sparged, for example with steam, to remove dissolved gases from the palatant composition.

The resultant palatant composition can be used to make a food product, preferably directly without any further processing after sparging. For example, the entire composition resulting from the sparging can be used as the palatant composition. In an embodiment, the resultant palatant composition can be applied directly to a food composition and/or incorporated into a food composition to enhance a palatability thereof.

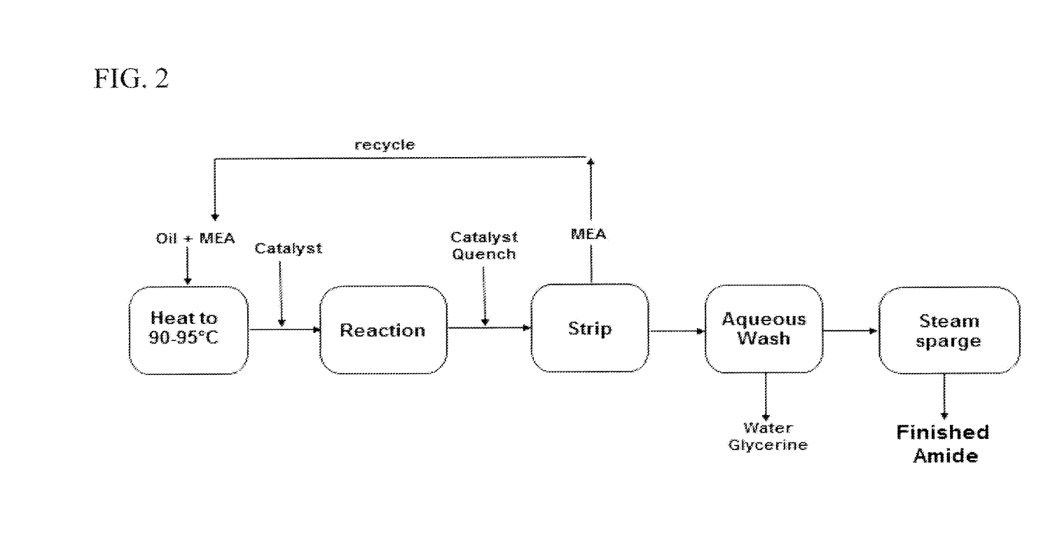

As shown in FIG. 2, in another embodiment provided by the present disclosure, XEA can be obtained by reacting MEA with a fat or oil, such as beef tallow, cocoa butter, palm oil, palm stearin, palm fractions, olive oil, hydrogenated oils, lard, high oleic safflower oil, and/or other fats/fat blends of comparable fatty acid profiles, followed by a cleanup process. For example, the MEA and the fat or oil can be mixed and then heated to a predetermined temperature, such as to a temperature of 90° C.-95° C. Then an amidation catalyst can be added to the heated mixture for the amidation reaction, for example by contacting the heated mixture of MEA and the fat or oil with an amidation catalyst for a predetermined time period and/or until the desired quantity of XEA is formed. Then the amidation catalyst can be quenched with a compound appropriate for the specific amidation catalyst, and the unreacted MEA can be stripped off using any process known to one of ordinary skill. The unreacted MEA can be recycled and used in subsequent amidation reactions. The amidation product can be washed with water to remove amidation by-products, such as glycerine; and then can be sparged, for example with steam, to remove dissolved gases from the palatant composition.

The resultant palatant composition can be used to make a food product, preferably directly without any further processing after sparging. For example, the entire composition resulting from the sparging can be used as the palatant composition. In an embodiment, the resultant palatant composition can be applied directly to a food composition and/or incorporated into a food composition to enhance a palatability thereof.

The palatant composition according to the present disclosure can be made by the processes in FIGS. 1 and 2 but is not limited to these processes. The palatant composition according to the present disclosure can be applied to the food composition as a coating, for example on a portion or an entirety of an outer surface of the food composition. The coating can be applied using any process known to one of ordinary skill, such as spraying or tumbling. The food composition can be a pet food, for example a dry pet food such as kibbles. Alternatively or additionally, the palatant composition can be incorporated into the ingredient mix that is used to make the food composition. For example, at least a portion of the palatant composition can be within the interior of the food composition after the food composition is made from the ingredient mix. In such an embodiment, the palatant composition can be substantially homogenously dispersed throughout the food composition. For example, the pet food can be a kibble made by extrusion-cooking, and the palatant composition can be incorporated into the kibble matrix blend before the extrusion-cooking. The amount of the palatant composition in and/or on the food composition can be 10-1000 ppm of the food composition.

The palatant composition can be used in pet treats or snacks using a similar application. The palatant composition can be used in a wet/canned product by mixing into the main ingredient prior to retort. The palatant composition can be delivered in a free-flowing, encapsulated form and packed in a sachet to use as supplement to main meals.

The food composition that is combined with the palatant composition can be formulated for consumption by a pet such as a companion animal. For example, the food composition can comprise meat, such as emulsified meat. Examples of suitable meat include poultry, beef, pork, lamb and fish, especially those types of meats suitable for pets. The meat can include any additional parts of an animal including offal. Additionally or alternatively, vegetable protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

The food composition that is combined with the palatant composition can comprise vegetable oil, a flavorant, a colorant and water. Suitable vegetable oils include soybean oil, corn oil, cottonseed oil, sunflower oil, canola oil, peanut oil, safflower oil, and the like. Examples of suitable flavorants include yeast, tallow, rendered animal meals (e.g., poultry, beef, lamb, pork), flavor extracts or blends (e.g., grilled beef), and the like. Suitable colorants include FD&C colors, such as blue no. 1, blue no. 2, green no. 3, red no. 3, red. no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The food composition that is combined with the palatant composition can optionally include additional ingredients, such as other grains and/or other starches additionally or alternatively to flour, amino acids, fibers, sugars, animal oils, aromas, other oils additionally or alternatively to vegetable oil, humectants, preservatives, polyols, salts, oral care ingredients, antioxidants, vitamins, minerals, probiotic microorganisms, bioactive molecules or combinations thereof.

Suitable starches include a grain such as corn, rice, wheat, barley, oats, soy and the like, and mixtures of these grains, and can be included at least partially in any flour. Suitable humectants include salt, sugars, propylene glycol and polyhydric glycols such as glycerin and sorbitol, and the like. Examples of preservatives that can be used include potassium sorbate, sorbic acid, methyl para-hydroxybenzoate, calcium propionate and propionic acid.

Suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Examples of suitable antioxidants include butylated hydroxyanisole (“BHA”) and butylated hydroxytoluene (“BHT”), vitamin E (tocopherols), and the like.

Examples of vitamins that can be used include Vitamins A, B-complex (such as B-1, B-2, B-6 and B-12), C, D, E and K, niacin and acid vitamins such as pantothenic acid and folic acid and biotin. Suitable minerals include calcium, iron, zinc, magnesium, iodine, copper, phosphorus, manganese, potassium, chromium, molybdenum, selenium, nickel, tin, silicon, vanadium, boron and the like.

Specific amounts for each additional ingredient in the food composition that is combined with the palatant composition will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

### EXAMPLE

The following non-limiting example is illustrative of various embodiments provided by the present disclosure.

Manufacturing Process

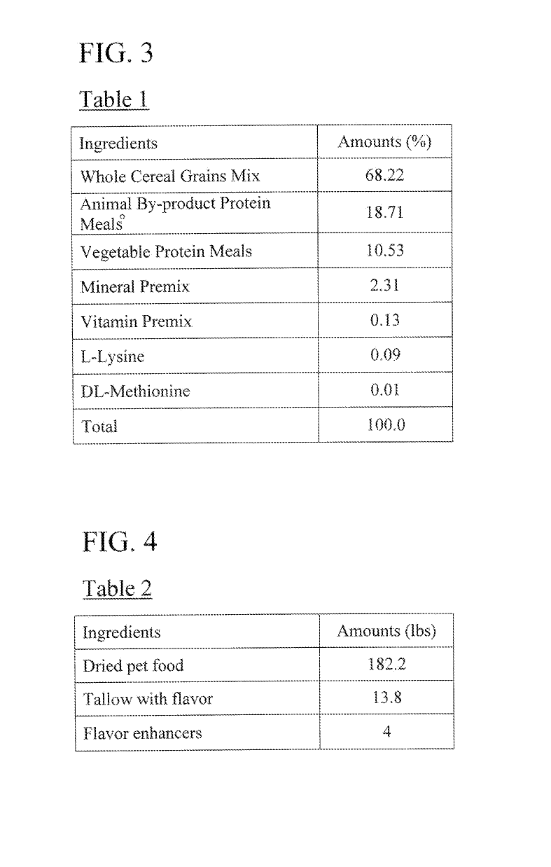

A Dog Chow product was produced using the ingredient showing in Table 1 (FIG. 3) and Table 2 (FIG. 4), 2,000 lbs of dry ingredient mix (Table 1) were fed into a pre-conditioner before entering into a single screw extruder with jackets for cooling or heating. Cooling water at room temperature was constantly passed through the jackets. The screw in the extruder was rotated at 230 rpm. The mixture was thus mechanically worked within the extruder at a temperature of around 238° F. and pressure of about 250 to 1,500 psig. The resultant dough-like material was continuously passed through a die with a 6 tri-angular shaped holes and cut using a rotating knife. Triangular-shaped pieces of pet food thus obtained were dried to a moisture content of 8%. Dried pet food pieces were coated with tallow with flavor enhancers (Table 2). This food served as a control food. For the test food rations. XEA ingredients were homogeneously mixed into tallow prior to fat spraying at a product formula rate of 100 ppm and 300 ppm, followed by standard application rates of flavor enhancer.

Palatability Testing

The control and test pet foods were tested for palatability and the results compared to determine if XEA enhanced the palatability of the test foods containing XEA. Palatability testing followed the industrial standard protocol for assessing preference, i.e., the two-bowl choice test. The dogs were tested individually inside their kennels. The panels consisted of a mix of breeds, distributed as equally as possible. The dogs were at least 12 months of age and the sex distribution was as equal as possible within panels. A choice of two bowls each with the same amount of food, the test and the control food, was offered simultaneously. The maximum length of the time the products were offered to the dogs was 20 minutes. Water was available at all times via an automatic water system. Bowl assignment for the foods was always counterbalanced.

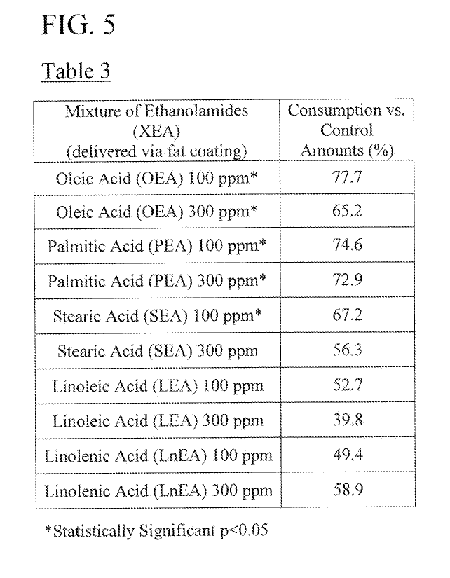

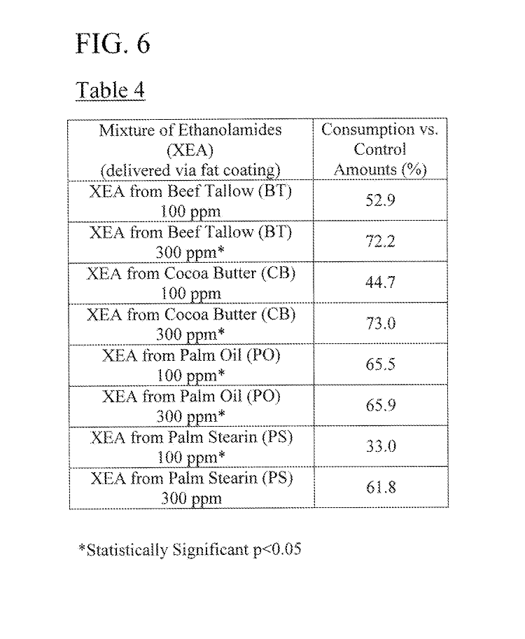

At the end of a test, food consumption for each pet food for each dog was determined by subtracting the amount of food remaining in the bowls from what was initially offered to the dogs. A dog's preference was determined based which food was most consumed. A food was considered significantly preferred if the number of dogs preferring the food was significantly greater than the number of dogs preferring the other food as determined by the Sign Test with an alpha-level (type 1 error) of 0.05. The results are shown in Table 3 (FIG. 5) and Table 4 (FIG. 6).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of enhancing the palatability of a food composition comprising:
subjecting mono-'ethanolamine (MEA) to a heat treatment and an amidation reaction with a mixture of different fatty acids to form a palatability composition comprising a mixture of different ethanolamides; and
mixing the palatability composition with the food composition.

2. The method of claim 1 wherein each of the different fatty acids is individually selected from the group consisting of oleic acid, palmitic acid, stearic acid, linoleic acid, and linolenic acid.

3. The method of claim 1 wherein the heat treatment is performed at a temperature of 115° C.-120° C.

4. The method of claim 1 wherein the amidation reaction comprises contacting the heated MLA with the mixture of different fatty acids for a predetermined time period.

5. The method of claim 1 wherein the mixing of the palatability composition with the food composition comprises coating the food composition with at least a portion of the palatability composition.

6. The method of claim 5 wherein the food composition is a pet food kibble that is coated with at least a portion of the palatability composition.

7. The method of claim 1 wherein the mixing of the palatability composition with the food composition comprises mixing at least a portion of the palatability composition in an ingredient blend that is used to make the food composition.

8. The method of claim 7 wherein the food composition is a pet food kibble, and the ingredient blend comprising at least a portion of the palatability composition is extruded to form the pet food kibble.

9. A method of enhancing the palatability of a food composition comprising:
subjecting mono-ethanolamine (MEA) and an oil to a heat treatment and an amidation reaction with an amidation catalyst to form a palatability composition comprising a mixture of different ethanolamides; and
mixing the palatability composition with the food composition.

10. The method of claim 9 wherein the oil is selected from the group consisting of beef tallow, cocoa butter, palm oil, palm stearin, palm fractions, olive oil, hydrogenated oils, lard, high oleic safflower oil, and combinations thereof.

11. The method of claim 9 wherein the heat treatment is performed at a temperature of 90° C.-95° C.

12. The method of claim 9 wherein the amidation reaction comprises contacting the heated MEA with the oil and the amidation catalyst for a predetermined time period.

13. The method of claim 9 wherein the mixing of the palatability composition with the food composition comprises coating the food composition with at least a portion of the palatability composition.

14. The method of claim 13 wherein the food composition is a pet food kibble that is coated with at least a portion of the palatability composition.

15. The method of claim 9 wherein the mixing of the palatability composition with the food composition comprises mixing at least a portion of the palatability composition in an ingredient blend that is used to make the food composition.

16. The method of claim 15 wherein the food composition is a pet food kibble, and the ingredient blend comprising at least a portion of the palatability composition is extruded to form the pet food kibble.

17. A food product comprising:
a pet food composition; and
a palatability composition made by a process comprising (i) subjecting mono-ethanolamine (MEA) to a heat treatment and an amidation reaction with a mixture of different fatty acids or (ii) subjecting MEA and an oil to a heat treatment and an amidation reaction with an amidation catalyst.

18. The food product of claim 17 wherein the pet food composition is a kibble, and the palatability composition is in a position selected from the group consisting of (i) a coating on the kibble, (ii) incorporated into a matrix of the kibble, and (iii) a combination thereof.

19. The food product of claim 17 w herein each of the different fatty acids is individually selected from the group consisting of oleic acid, palmitic acid, stearic acid, linoleic acid, and linolenic acid.

20. The food product of claim 17 wherein the oil is selected from the group consisting of beef tallow, cocoa butter, palm oil, palm stearin, palm fractions, olive oil, hydrogenated oils, lard, high oleic safflower oil, and combinations thereof.

21. A palatability composition made by a process comprising (i) subjecting mono ethanol amine (MEA) to a heat treatment and an amidation reaction with a mixture of different fatty acids or (ii) subjecting MEA and an oil to a heat treatment and an amidation reaction with an amidation catalyst.
